(19) United States
(12) Patent Application Publication
(10) Pub. No.: US 2002/0189903 A1
(43) Pub. Date: Dec. 19, 2002

(54) Truck bed ladder system

(76) Inventor: Ted Krish JR., Louisville, KY (US)

Correspondence Address: Scott R Cox, Lynch Cox Gilman & Mahan P S C, 400 West Market St, Suite 2200, Louisville, KY, 40202, US

(21) Appl. No.: 09/540,146

(22) Filed: Mar. 31, 2000

Related U.S. Application Data
(63) Continuation-in-part of application No. 09/280,402, filed on Mar. 29, 1999, now Pat. No. 6,058,875.
Application No. 09/280,402 is a continuation-in-part of application No. 08/993,366, filed on Dec. 18, 1997, now Pat. No. 5,887,540.

(51) Int. Cl. E06C 1/36

(52) U.S. Cl. 182/206

(57) ABSTRACT

A removable truck bed ladder system for use with truck beds of trucks, including a ladder step system which includes a plurality of steps, an attachment hook secured to one end of the ladder step system, a rotational hinge pin assembly secured to the ladder step system and a hand rail assembly rotationally secured to the ladder step system by the rotational hinge pin assembly.

### RELATED ART

This application is a continuation-in-part of application Ser. No. 09/280,402, filed Mar. 29, 1999, which was a continuation-in-part of application Ser. No. 08/993,366, filed Dec. 18, 1997, now U.S. Pat. No. 5,887,540, which issued on Mar. 30, 1999.

### BACKGROUND OF INVENTION

1. Field of Invention

This invention relates to a ladder system for attachment to a truck bed of a trailer truck. More particularly it relates to a detachable ladder system for attachment to the rail or side of a truck trailer, which system contains a rotatable hand rail assembly.

2. Description of Related Art

The truck bed of truck trailers is often difficult to access because of its height above ground. There is an as yet unfilled need for a portable ladder assembly which is adaptable to be used with a truck trailer and is yet removable for easy storage. The ladder desirably should be easily attachable to the side or end of the truck bed and contain hand rails secured to the ladder to facilitate individuals climbing the side of the truck and entering the truck bed. It is important that this type of ladder system be both easily and quickly mountable to the truck bed and also easily and quickly removable after use has been completed for storage.

There are a significant number of prior art ladder systems designed for use with different types of trucks. For example, U.S. Pat. No. 5,024,292 discloses a portable ladder assembly for truck trailers which uses a rather complicated spring loaded system which sets on the ground and is extended up within the rail at the back of a truck bed.

U.S. Pat. No. 5,687,813 discloses a detachable ladder system for use with military vehicles which utilizes a c-shaped bracket (24) attached to the ladder system which fits over the tailgate of the vehicle. The ladder contains extensions (28) which are secured by pins (38) to the ladder and can act as hand rails.

U.S. Pat. No. 4,482,029 discloses a pivotal ladder assembly for attachment to the side of a truck, wherein the ladder (10) is secured to a bracket assembly (30) containing a pivotal bracket (30), which can be placed over the side of the truck box.

Another ladder assembly which includes inner and outer ladders for use within truck boxes is disclosed in U.S. Pat. No. 4,492,286.

Another ladder assembly for use with trucks is disclosed in U.S. Pat. No. 3,908,260. See a similar ladder assembly in U.S. Pat. No. 3,882,965.

A number of truck ladder assemblies have also been designed for use with a tailgate of a truck and are generally designed to be fixedly secured to the tailgate, as shown for example, in U.S. Pat. Nos. 5,617,930, 5,028,063, 4,161,997, 3,858,905, 4,848,821, 4,757,876 and 5,549,312.

In addition, other ladder assemblies have been designed to be secured to the underside of a truck bed, such as U.S. Pat. Nos. 4,205,862 and 4,093,257.

Additional ladder assemblies for vehicles are designed to be used with the truck bed or other raised portion of the vehicle. After use, those assemblies are slid within a cavity contained in the vehicle. See, for example, U.S. Pat. Nos. 5,228,707, 5,366,052, 5,205,603, 4,139,078 and 3,563,342.

Other ladder assemblies designed for use with off-highway machines are disclosed in U.S. Pat. Nos. 5,813,494 and 4,990,049.

Many of these ladder systems are designed to be fixedly secured to the truck trailer and therefore are difficult to be used quickly. Further, conventional ladders are difficult to use with truck beds as the height of the truck beds may vary.

In addition, current removable truck bed ladders are frequently difficult to attach to truck beds.

In addition, when these prior art truck bed ladder systems are used, there is often a danger of pinching of the hands of the individual who is installing and using the truck bed ladder system.

Further, it is important that these truck bed ladder systems be securely attached to the rail or side or stake pocket of the truck bed while in use. It is also important that these truck bed ladder systems be easily removable for storage on the truck.

Accordingly, it is an aspect of this invention to disclose a truck bed ladder system for use with conventional truck beds.

It is a still further aspect of this invention to disclose a truck bed ladder system which easily attaches to the stake pockets, rub rails or side of the truck bed by use of a hook system.

It is a still further aspect of the invention to disclose a truck bed ladders system which includes a hand rail assembly, wherein the hand rail assembly is rotationally secured to the truck bed ladder system.

It is a still further aspect of the invention to disclose a truck bed ladder system containing a hand rail assembly which can easily be rotated from its stored position to its preferred position of use without the use of pins.

These and other aspects of the invention can be obtained by the disclosed truck bed ladder system.

### SUMMARY OF INVENTION

The present invention is a truck bed ladder system (10) for use with trucks or truck beds, which includes a ladder step system (20), a rail and side pocket attachment hook (40), secured to the ladder step system (20), and a rotational hand rail assembly (60), secured to the ladder step system by a pin assembly (30).

In a preferred embodiment, the rail and side pocket attachment hook (40) includes a hand rail post sleeve (46) for receiving and holding the hand rail assembly (60) in a vertical position in relation to a truck bed for use with the ladder step system (20).

In a further preferred embodiment, the ladder step system (20) and the hand rail assembly (60) further includes a system of plungers (64) and keepers (65) which allow the hand rail (62) to be stored against the sides of the ladder step system (20).

In a further preferred embodiment, the ladder step system (20) further includes a swivel ladder rung (29) secured to the bottom of the ladder step system (20) to assist in utilization of the truck bed ladder system (10) when the truck bed is an exceptionally great distance above the ground.

### BRIEF DESCRIPTION OF THE DRAWINGS

FIG. 1 is a perspective view of the truck bed ladder system installed in the rail of a truck bed.

FIG. 2 is a side perspective view of the truck bed ladder system with the hand rail assembly placed in a stored position.

FIG. 3 is a side perspective view of the truck bed ladder system with the hand rail assembly secured in position for use.

FIG. 4 is a side perspective view of the rail and side pocket attachment hook of the truck bed ladder system.

FIG. 5 is a top view of the rail and side pocket attachment hook of FIG. 4 of the truck bed ladder system.

FIG. 6 is a cutaway side view of the top portion of the hand rail assembly, rotationally secured to the ladder step system.

FIG. 7 is the side view of a side plate of the ladder step system.

### DETAILED DESCRIPTION OF THE PREFERRED EMBODIMENT

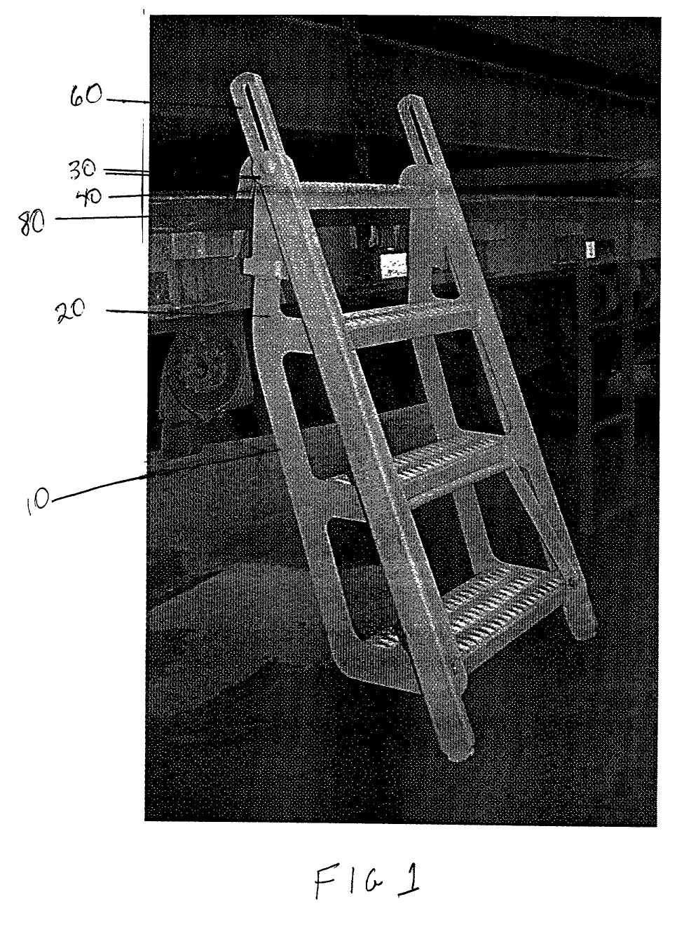

The present invention is a truck bed ladder system (10) preferably for use with truck beds (80) and includes a ladder step system (20), a rail and side pocket attachment hook (40), a rotational hinge pin assembly (30), and a hand rail assembly (60), rotationally secured to the ladder step system (20) by the rotational hinge pin assembly (30) as shown in FIGS. 1, 2 and 3. The truck bed ladder system (10) may be attached to any type of vehicle. However, in one preferred embodiment as shown in FIG. 1, it is specifically designed for attachment in the stake pockets or rub rails of a flat bed trailer and to the rail and side of a truck bed (80) of trailers. The ladder step system (20) of the truck bed ladder system (10) is designed to assist individuals attempting to climb into the truck bed (80) of a conventional truck.

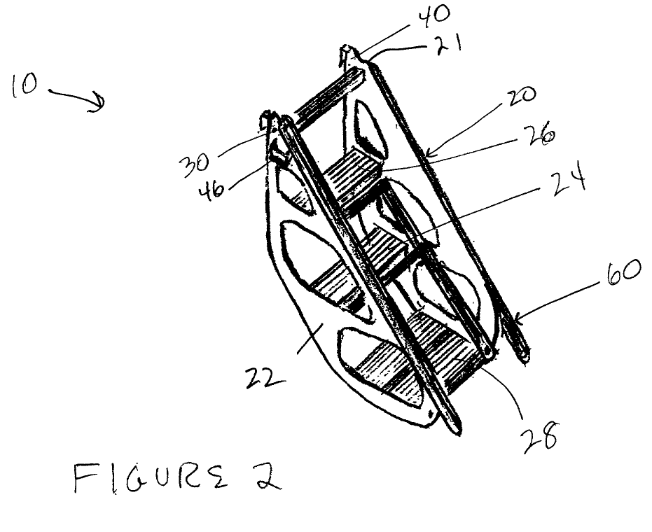

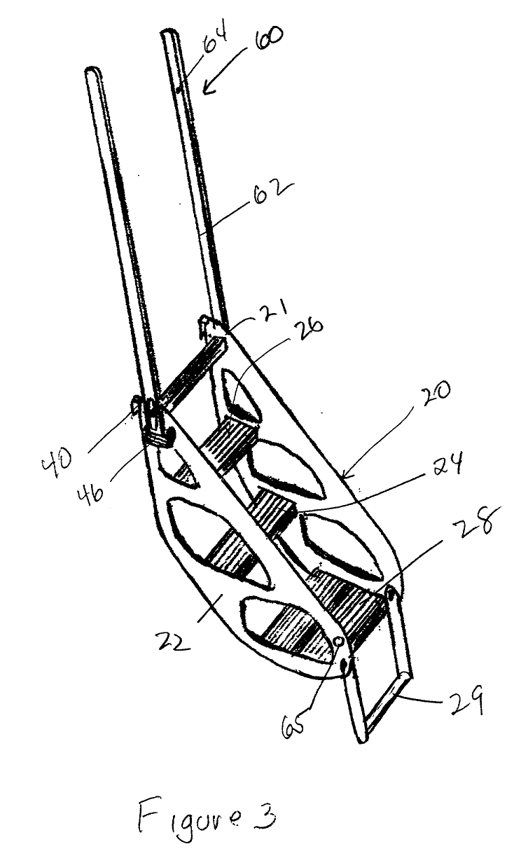

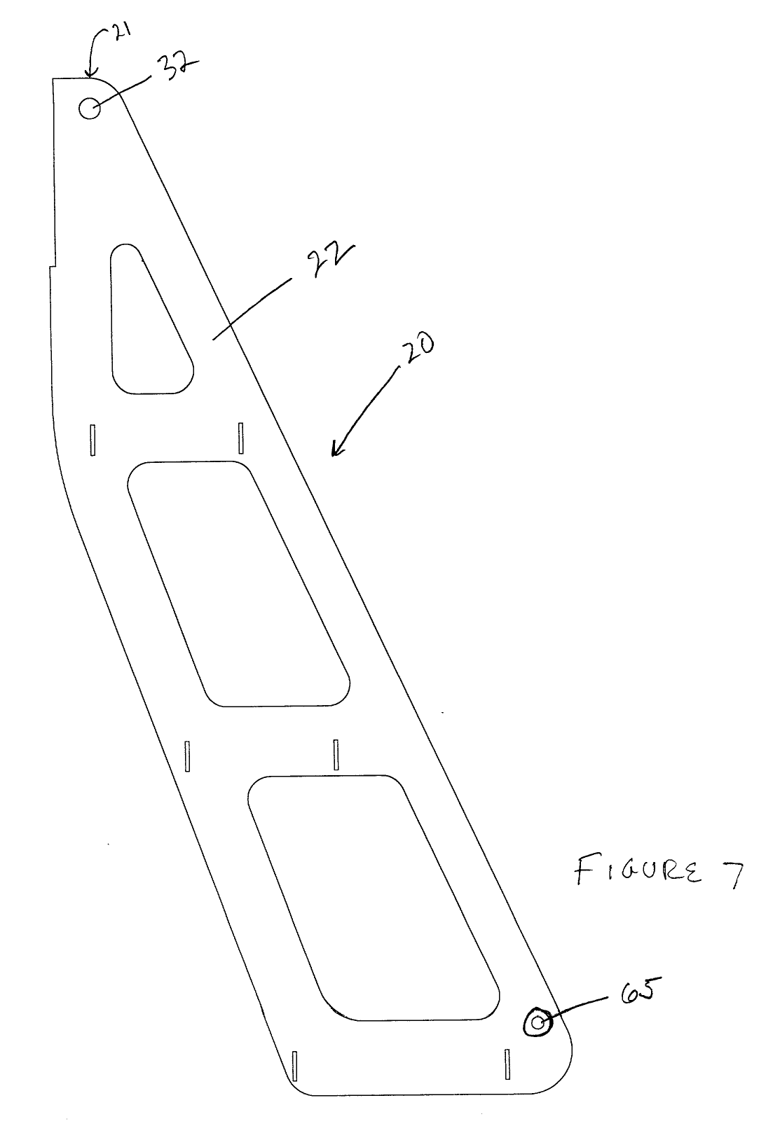

The ladder step system (20) as shown in FIGS. 2 and 3 includes a frame (22), as shown in FIG. 7, to which steps (24) of the system (10) are secured by a conventional means, such as by bolts or welding. The frame (22) and steps (24) may be constructed of conventional, generally lightweight material, such as aluminum or plastic. The ladder step system (20) may contain any number of individual steps (24). In one preferred embodiment there is in addition to the conventional steps (24) a platform (28) secured near the bottom of the ladder step system (20). The width of the individual steps (24) and platform (28) can vary, preferably from about 18 inches to about 3 feet in width, although other widths are within the scope of the present invention.

In one preferred embodiment as shown in FIG. 3, there is also attached to the platform (28) of the ladder step system (20) a swivel ladder rung (29). This swivel ladder rung (29) is secured to the frame (22) by a conventional means which allow it to swivel around the attachment point. Thus, preferably the swivel ladder rung (29) is secured near the bottom of the frame (22) by pivot pins or other securing system which permits the swivel ladder to pivot around these pins. In addition, for storage purposes, the swivel ladder rung (29) is rotated upward and around the platform (28) and is then secured in place against the inside of the frame (22) by a conventional securing systems, such as Velcro® strap, or snap straps.

The top surface (26) of each step (24) and platform (28) is preferably formed from a roughened material to provide better traction for individuals attempting to climb those steps (24) for entry to the truck bed (80). Alternatively, a roughened material can be secured to the top of each step (24) to provide better traction for the user of the system (10).

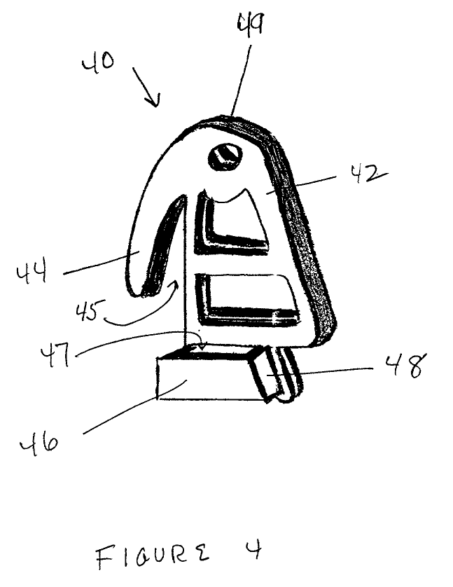

Secured to the top of the frame (22) of the ladder step system (10) is the rail and side pocket attachment hook (40) as shown in FIGS. 1, 4 and 5. This rail and side pocket attachment hook (40) is conventionally comprised of a body portion (42) and a hook (44). The top (49) of the attachment hook (40) is generally located near the top (21) of the ladder step system (20) as shown in FIGS. 2 and 3. The hook (44) preferably runs the entire height of the rail and side pocket attachment hook (40) with the space (45) between the hook (44) and the body portion (42) preferably increasing down the side of the attachment hook (40) as shown in FIG. 4. Preferably, the size of this space (45) at its top is from about ¼ to about ½ of an inch in width increasing in size to more than an inch near the bottom of the attachment hook (40). The body portion (42) of the rail and side pocket attachment hook (40) is secured to the ladder step system (20) by a conventional securing system such as by welding the two components together or by the use of rivets or pins. Alternatively, the attachment hook (40) can be formed as a component of the ladder step system (20).

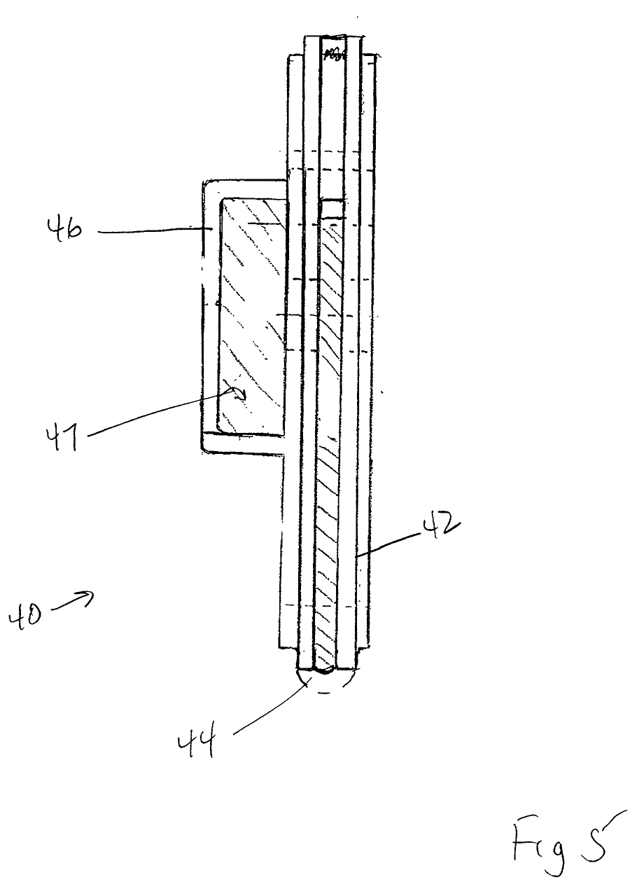

The attachment hook (40) further includes a hand rail post sleeve (46) into which one end (63) of the hand rail (62) is placed when the hand rail is secured in a vertical position in relation to the truck bed (80) as shown in FIG. 3. Preferably, the hand rail post sleeve (46), as shown in FIGS. 4 and 5 contains an open slot (47) to receive the end of the hand rail (62). Preferably, one side (48) of the hand rail post sleeve (46) is angled to support the hand rail (62) when it is placed in its stored position, as shown in FIG. 2.

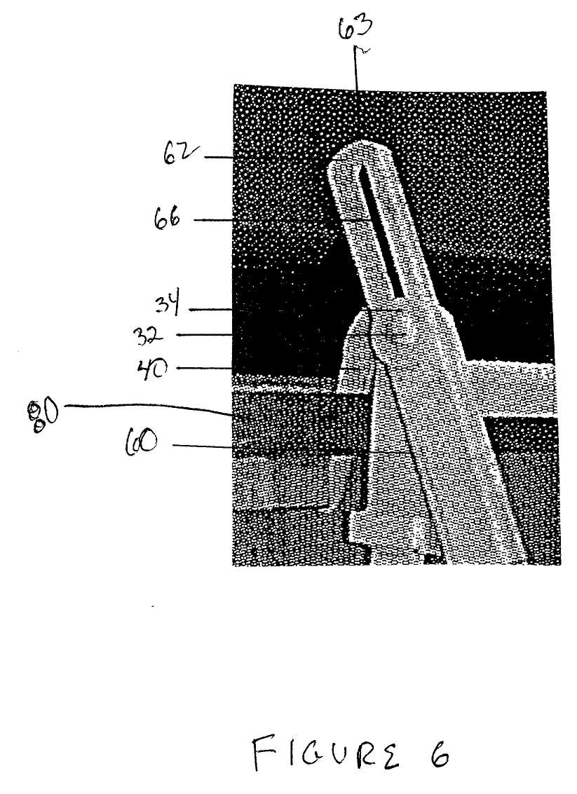

Near these two tops (21, 49) of the components is secured the rotational hinge pin assembly (30) which includes a pin (32) and a hand rail retainer (34) which extend outwardly from the attachment hook (40) as shown in FIG. 6. The pin (32) extends through the ladder step system (20) and the attachment hook (40) and extends outwardly at least about one (1) inch and preferably from about one (1) to two (2) inches. The hand rail retainer (34) is secured onto the outer end of the pin (32) by a conventional securing system, such as by welding it in place. Any form of retaining element which retains the hand rail assembly (60) against the ladder step system (20) is within the scope of the invention. Preferably, the hand rail retainer (34) is a washer fixedly secured to the pin (32). The hand rail retainer (34) retains the hand rail assembly (60) on the pin (32) while still permitting the free rotation of the hand rail assembly (60) about the pin (32).

The hand rail assembly (60) includes the hand rail (62) which contains a slot (66) in which the pin (32) of the rotational pin assembly (30) slides as shown in FIGS. 1 and 6. The hand rail (62) is preferably an extended, generally rectangular piece of metal at least about 2 feet in length, preferably aluminum, which can assist the individual climbing the steps (24) of the ladder step system (20) to enter the truck bed (80). When the hand rail assembly (60) is in the position shown in FIG. 3, one end (63) of each hand rail (62) is placed within the slot (47) of the hand rail post sleeve (46). In order to place this end (63) of the hand rail (62) within the hand rail post sleeve (46), the hand rail (62) is rotated around the pin (32) of the rotational hinge pin assembly (30) until the end (63) of the hand rail assembly (62) is directly above the slot (47) of the hand rail post sleeve (46). The hand rail (62) then slides on the pin (32) until the end (63) rests within the slot (47) of the hand rail post sleeve (46). By placing the hand rail (62) within the hand rail post sleeve (46) frontward and backward movement of the hand rail (62) in relation to the ladder step system (20) is restricted. The length of the slot (66) cut into the side of the hand rail (62) is such as to allow the hand rail (62) to slide downward around the pin (32) of the rotational hinge pin assembly (30) at least about six (6) inches or so.

When the hand rail (62) is not in use, it is pulled upward until the end (63) is no longer restrained within the slot (47) of the hand rail post sleeve (46). The hand rail (62) is then rotated about the pin (32) downward along the sides of the frame (22) of the ladder step system (20) until it rests against the angled side (48) of the hand rail post sleeve (46). Preferably there is secured onto the hand rail (62) aluminum plungers (64) which fit within rubber keepers (65) secured to the frame (22) of the ladder step system (20) to hold the hand rail (62) in a stored position as shown in FIGS. 3 and 7. These plungers (64) and keepers (65) can be any system which permits the handrails (62) to be secured against the frame (22) when not in use. Preferably the plunger (64) is an aluminum plunger and the keeper (65) is a rubber socket designed to receive and hold the plunger (64), such as is manufactured by Thomas Hardware and referred to as “door holders”.

In operation, the truck bed ladder system (10) is removed from its storage location and carried to the back or side of a truck bed (80) where the rail and side pocket attachment hook (40) is placed over the rail or side or into the stake pocket or rub rail of the truck bed (80). The hook (44) itself rests over this rail or within the side of the truck bed (80). Depending upon the height of the truck bed (80), the swivel ladder rung (29) may be rotated from its stored position until it swivels freely below the platform (28). The individual using the truck bed ladder system (10) then rotates the hand rails (62) from their stored position against the inside of the frame (22) until they are raised to a vertical position. The end (63) of each hand rail (62) is then slid into the respective hand rail post sleeves (46). This holds the hand rails (62) securely in position. With the truck bed ladder system (10) thus secured to the rail or side pocket of the truck bed (80), the individual may climb up the ladder assembly (10) to the truck bed (80) and come down the ladder assembly (10) with ease.

It will be apparent from the foregoing, while particular forms of the invention have been illustrated, various modifications can be made without departing from the spirit and scope of the invention. Accordingly, it is not intended to limit the invention to be so limited.

1. A truck bed ladder system comprising
a ladder step system,
a rotational hinge pin assembly secured to the ladder step system,
an attachment hook secured to the ladder step system, and
a hand rail assembly rotationally secured to the ladder step system by the rotational hinge pin assembly.

2. The truck bed ladder system of claim 1 wherein the attachment hook comprises a body portion, a hook element and a hand rail post sleeve, wherein the hand rail post sleeve can receive the hand rail assembly to secure it in a vertical position in relation to a truck bed to which the ladder system is secured.

3. The truck bed ladder system of claim 1 wherein the ladder step system comprises a frame and a plurality of steps secured to the frame.

4. The truck bed ladder system of claim 3 further comprising a swivel ladder rung secured to the frame of the ladder step system.

5. The truck bed ladder system of claim 1 wherein the rotational pin assembly further comprises a hand rail retainer.

6. The truck bed ladder system of claim 1 wherein the hand rail comprises an extended rail with a slot cut in that extended rail.

7. The truck bed ladder system of claim 6 wherein the hand rail is rotationally secured to the ladder step system by passing the rotational pin through the slot of the hand rail.

8. The truck bed ladder system of claim 1 wherein the ladder step system further comprises a keeper and the hand rail assembly further comprises a plunger which operate to secure the hand rail assembly against the ladder step system.

9. A truck bed ladder system comprising
a ladder step system,
a rotational hinge pin assembly secured to the ladder step system,
an attachment hook secured to the ladder step system, and
a hand rail assembly rotationally secured to the ladder step system by the rotational hinge pin assembly, wherein the attachment hook comprises a body portion, a hook element and a hand rail post sleeve, wherein the hand rail post sleeve receives the hand rail assembly to secure it in a vertical position in relation to a truck bed to which the ladder system is secured.

10. The truck bed ladder system of claim 9 wherein the ladder step system comprises a frame and a plurality of steps secured to the frame.

11. The truck bed ladder system of claim 10 further comprising a swivel ladder rung secured to the frame of the ladder step system.

12. The truck bed ladder system of claim 9 wherein the rotational pin assembly further comprises a hand rail retainer.

13. The truck bed ladder system of claim 9 wherein the hand rail comprises an extended rail with a slot cut in that extended rail.

14. The truck bed ladder system of claim 13 wherein the hand rail is rotationally secured to the ladder step system by passing the rotational pin through the slot of the hand rail.

15. The truck bed ladder system of claim 9 wherein the ladder step system further comprises a keeper and the hand rail assembly further comprises a plunger which operate to secure the hand rail assembly against the ladder step system.

16. A truck bed ladder system comprising
a ladder step system,
a rotational pin assembly secured to the ladder step system,
an attachment hook secured to the ladder step system, and
a hand rail assembly rotationally secured to the ladder step system by the rotational pin assembly, wherein the attachment hook comprises a body portion, a hook element and a hand rail post sleeve, wherein the hand rail comprises an extended rail with a slot cut in that extended rail, wherein the hand rail is rotationally secured to the ladder step system by passing the rotational pin through the slot of the hand rail.

17. The truck bed ladder system of claim 16 wherein the ladder step system comprises a frame and a plurality of steps secured to the frame.

18. The truck bed ladder system of claim 17 further comprising a swivel ladder ring secured to the frame of the ladder step system.

19. The truck bed ladder system of claim 16 wherein the rotational pin assembly further comprises a hand rail retainer.

20. The truck bed ladder system of claim 16 wherein the ladder step system further comprises a keeper and the hand rail assembly further comprises a plunger which operate to secure the hand rail assembly against the ladder step system.
